(19) United States
(12) Patent Application Publication
(10) Pub. No.: US 2018/0335789 A1
(43) Pub. Date: Nov. 22, 2018

(54) SIPHON FLOAT SYSTEM

(71) Applicant: Frank Leverett Bullard, IV, Beaufort, SC (US)

(72) Inventor: Frank Leverett Bullard, IV, Beaufort, SC (US)

(21) Appl. No.: 15/600,981

(22) Filed: May 22, 2017

(51) Int. Cl. G05D 7/01; F16K 31/18; E03F 1/00

(52) U.S. Cl. CPC G05D 7/0153; E03F 1/001; F16K 31/18

(57) ABSTRACT

A siphon float system comprises a central dowel in communication with a batch reactor. A siphon float is slidably engaged with the central dowel, wherein the siphon float is hydraulically operated. A plurality of valves are in communication with the siphon float, wherein the plurality of valves selectively control a flow of water. one or more dowel pegs contact one or more valve triggers based on a level of fluid in the batch reactor; and a plurality of hoses to direct the flow of water.

### CROSS-REFERENCE TO RELATED APPLICATION(S)

Not applicable

### BACKGROUND OF THE INVENTION

### 1. Field of Invention

The present invention relates to a siphon float system, which controls fluid levels and pollutive particle capture within a batch reactor system.

### 2. Description of Related Art

The ability of a batch reactor to capture pollutive particles within fluid is essential to prevent downstream contamination of other batch reactors or, for example, streams that are negatively affected by these particles. An order for the batch reactor to capture the particles adequately, the treated reactor fluid may by pumped or by other means out of the reactor an order to create the necessary storage volume needed to be treated in future scenarios.

Certain specific applications of man-made batch reactors include stormwater retention ponds, waste water treatment facilities, septic treatment systems and grease traps which inherently result in fluctuating fluid and pollutive particle levels. Such fluctuation resulting in additional fluid and pollutive particles within batch reactor systems and require outfall systems to address the increased pollutive particle and fluid levels. These pollutive particles become mixed with fluid produced from upstream disturbance, contamination, or pollution.

Other man-made or engineered batch reactor systems are subject to environmental factor resulting in fluctuations in the level or elevation of fluid within a batch reactor. Such changes can result in contamination of downstream batch reactor or, for example, rivers. This contamination can alter and destroy these downstream batch reactors and/or environments resulting in the destruction of the environment. These fluctuations are currently controlled by systems that pump the fluid out of the system creating the necessary void of volume for a fluctuation of fluid. Other systems overflow and discharge the batch reactor system immediately upon a fluctuation in fluid, which fail to store any volume of fluid for an amount of time to be treated by the batch reactor.

Current batch reactor systems, where they provide for attempts to actively control-fluid levels require extensive electrical infrastructures operating pumps to control the fluid levels that ultimately control the volume capacity of a batch reactor system. Such pump operation is extremely susceptible to malfunction, power outages, and a waste of energy resources. Further the analysis results in increased man hours for oversight of the operations.

Based on the foregoing, there is a need in the art a Siphon Float System operating on mechanical and hydraulic principals allowing for an autonomous or automated system to control water levels without the susceptibility of an electrical or pump reliant system.

### SUMMARY OF THE INVENTION

A siphon float system comprises a central dowel in communication with a batch reactor. A siphon float is slidably engaged with the central dowel, wherein the siphon float is hydraulically operated. A plurality of valves are in communication with the siphon float, wherein the plurality of valves selectively control a flow of water. One or more dowel pegs contact one or more valve triggers based on a level of fluid in the batch reactor; and a plurality of hoses to direct the flow of water.

In an embodiment, the siphon float is hydraulically operated through a method comprising the steps of first, submerging the siphon float into the batch reactor. Then a siphon pipe in communication with the siphon float fills with water and the water displacing air within the system. Then the siphon float manages a level of the batch reactor based on the mean high water elevation.

In an embodiment, the siphon float system further comprising one or more filters disposed within the siphon float.

In an embodiment, the siphon float further comprises one or more legs configured to engage a bottom surface of the batch reactor. A floatation base is attached to the one or more legs, wherein the plurality of valves is disposed on the floatation base. A siphon pipe extends outward from the floatation base, wherein the plurality of valves control the flow of water within the siphon pipe.

In an embodiment, the siphon float system comprises a delay trigger system in control with the plurality of valves, wherein the delay trigger system controls selective operation of the plurality of valves.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side cross section view of the control tower for a stormwater pond design for the Siphon Float System, according to an embodiment of the present invention;

FIG. 2 is a perspective side view of the siphon float for a stormwater pond design for the Siphon Float System, according to an embodiment of the present invention.

FIG. 3 is a side view of the septic/grease trap design with a siphon float application for the Siphon Float System, according to an embodiment of the present invention.

FIG. 4 is a cross section side view of a stormwater pond design of the Siphon Float System, according to an embodiment of the present invention.

FIG. 5 is a cross section side view of a septic tank design of the Siphon Float System, according to an embodiment of the present invention.

FIG. 6 is a cross section side view of a stormwater pond distribution box of the Siphon Float System, according to an embodiment of the present invention.

FIG. 7 is a site plain view of a stormwater pond with siphon float of the Siphon Float System, according to an embodiment of the present invention.

FIG. 8 is a side cross section side view of a wastewater treatment facility of the Siphon Float System, according to an embodiment of the present invention.

### DETAILED DESCRIPTION OF PREFERRED EMBODIMENTS

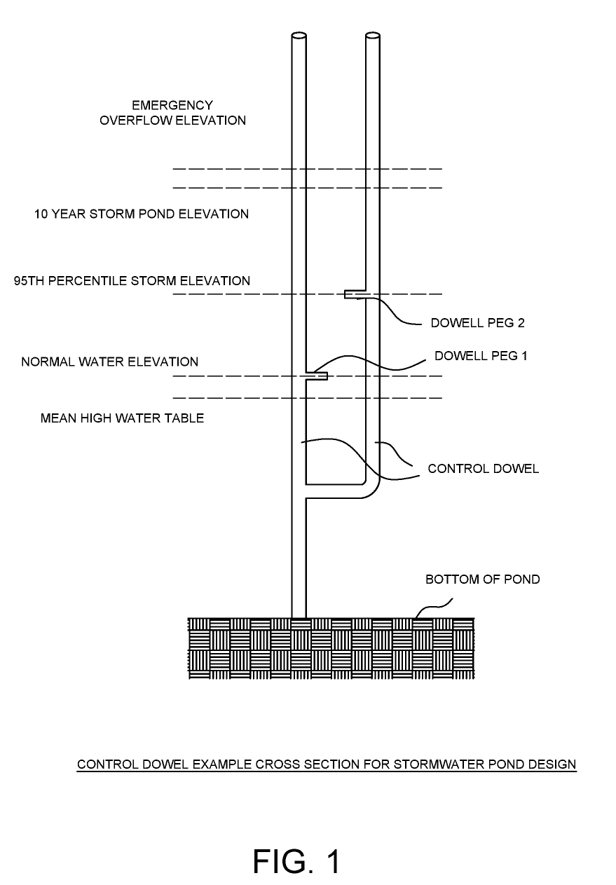

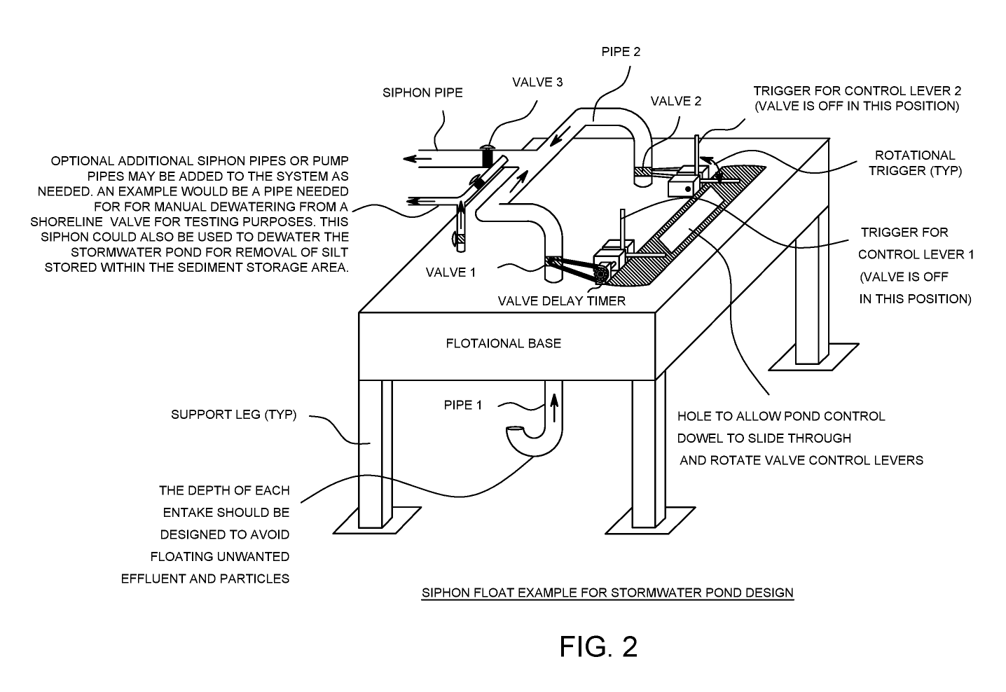

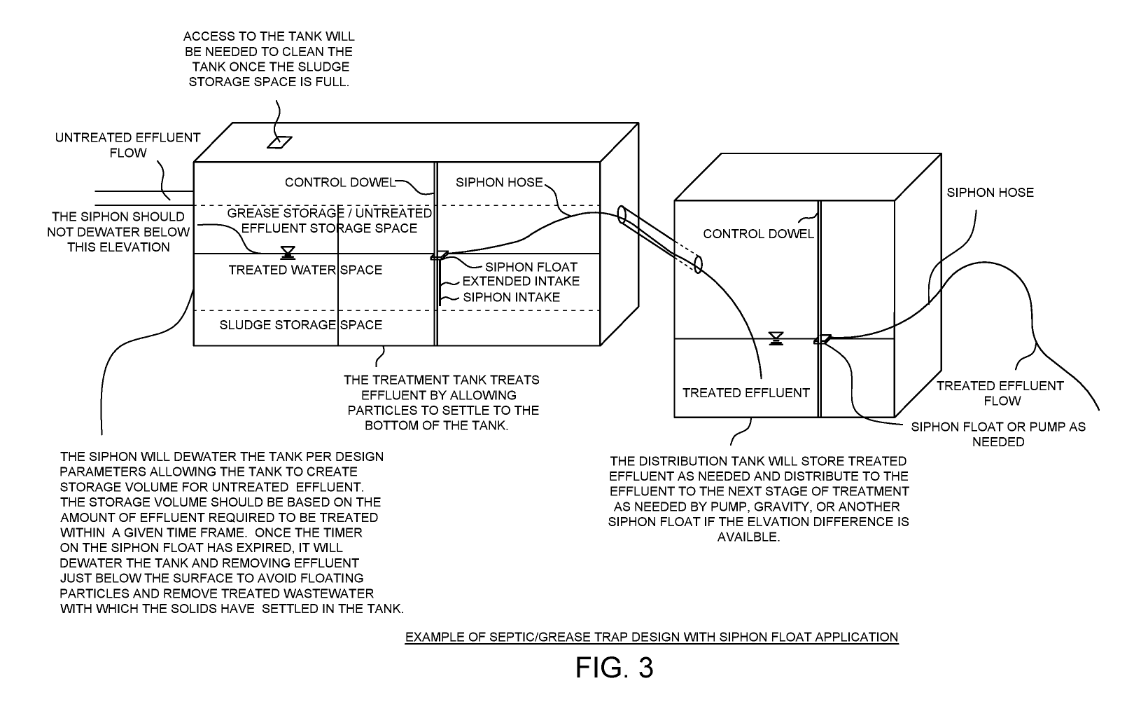

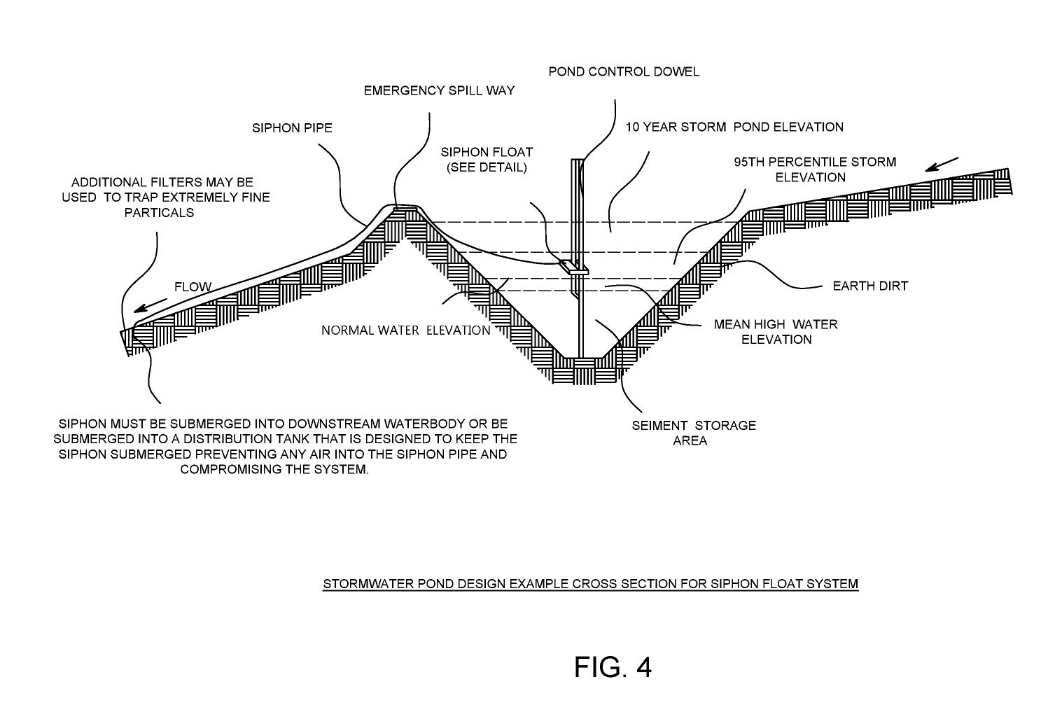

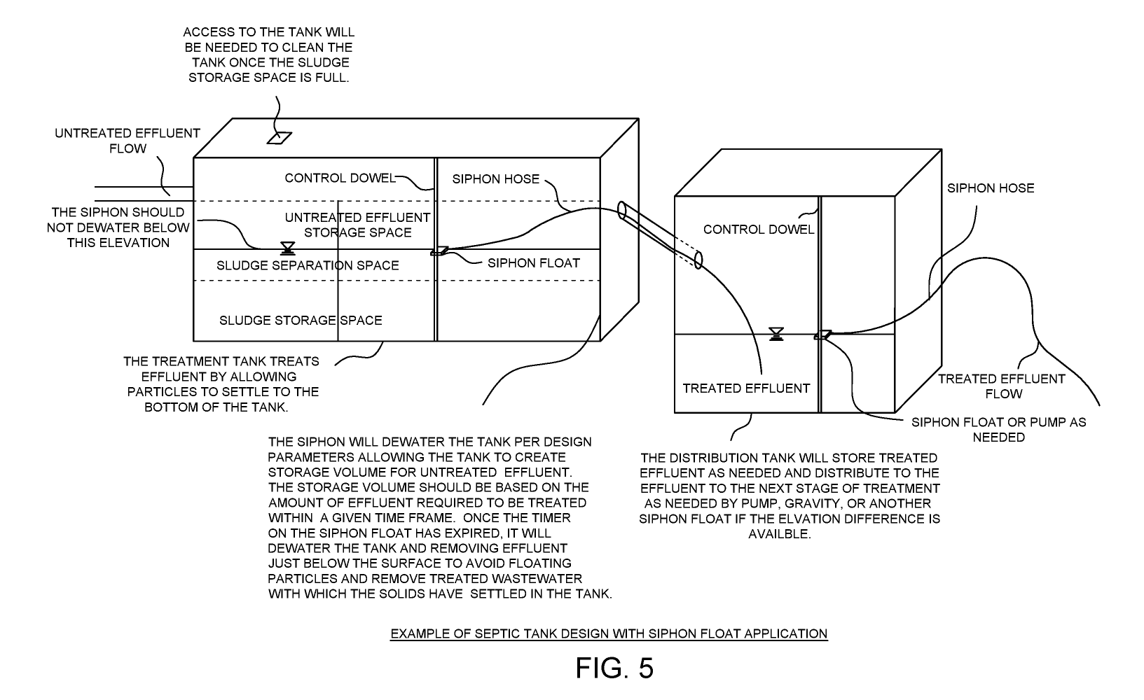

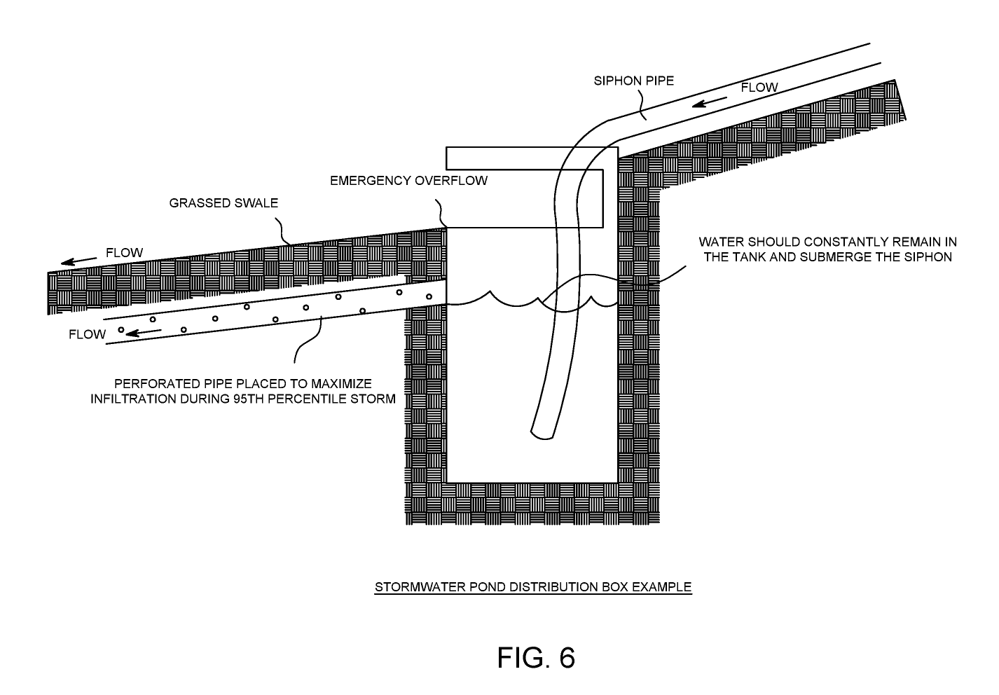

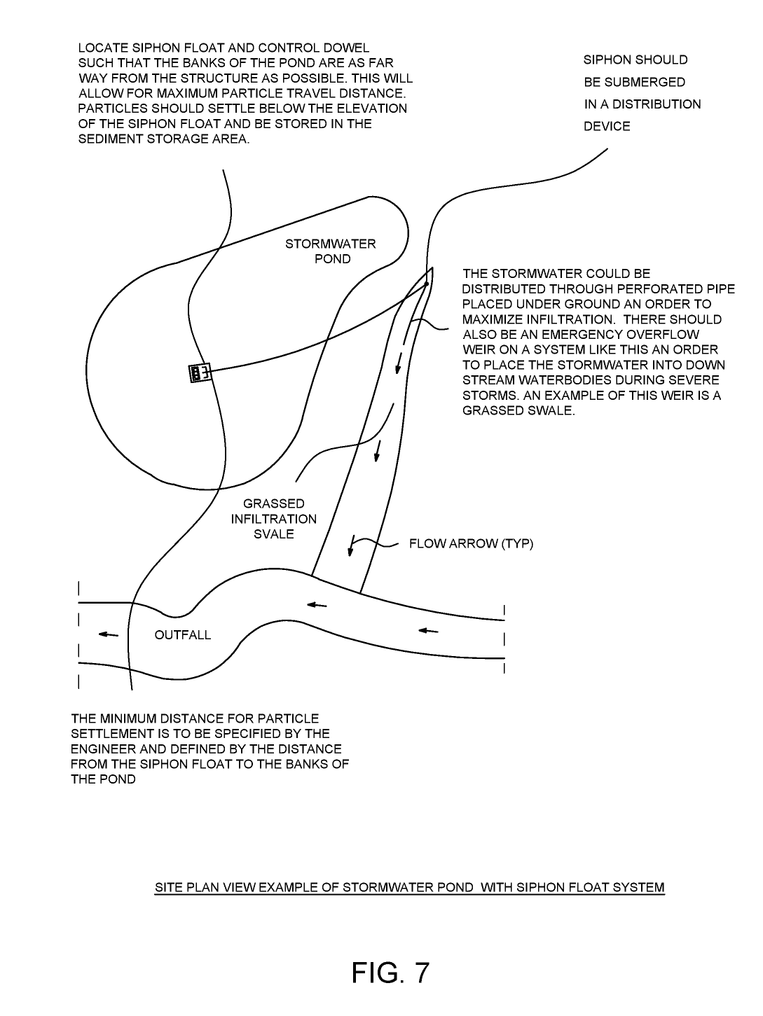

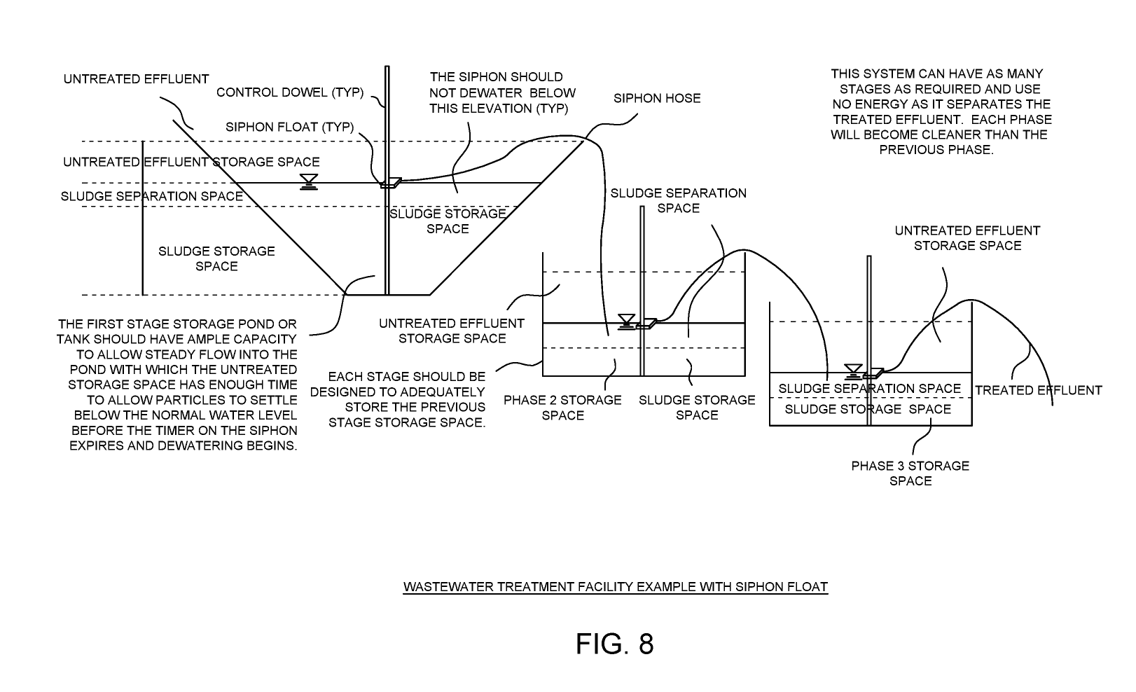

Preferred embodiments of the present invention and their advantages may be understood by referring to FIGS. 1-8, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

The siphon float system has a plurality of hoses and tubing in communication to direct the flow of fluids into or out of a batch reactor system for intended and purposefully control of elevation of fluid within a batch reactor system. A plurality of valves are disposed throughout the siphon float system to selectively prevent and allow flow of fluid within the system. A siphon pipe initially fills or is filled with fluid providing hydraulic pressure for operation of the system. General gravitation principals acting on fluids within the batch reactor system relative to the elevation change of fluid within the siphon pipe facilitate the continuous flow of fluid either into or out of the a batch reactor system. Control dowels extend the depth of the batch reactor system having a siphon float attached that is held in place horizontally but allowed to slide up and down the control dowel vertically. A more traditional pump system may use the parts of the siphon float system to operate, which may be used based upon additional design requirements. An additional siphon may also be placed on the siphon float system that is controlled from outside the batch reactor by an operator and accessed easily for testing purposes.

In order to set the siphon float system up placing it into operation, the siphon pipe must be filled with fluid with no air pockets in the pipe. To achieve this, the siphon pipe could be submerged or pumped full of fluid and sealed with valves once filled until each end of the siphon is submerged and there is no air within the siphon pipe. Once the siphon is full of fluid, the siphon will be operable and the valves may be opened to discharge fluid from the batch reactor.

Referencing the siphon float figure as an example of use within a stormwater retention pond. A first valve control trigger in communication with one or more of the plurality of valves acts to control operation of the valves whereby the valves are opened and closed in a predetermined order to control the fill and discharge of fluid within the siphon pipe. A dowel peg selectively contacts the valve control-trigger based on a level of fluid within the stormwater retention pond. For example, the valve control trigger rotated as it is contacted by the dowel peg and as the body of water is drained, the valve is closed when the dowel peg contacts the valve control lever.

Referencing the siphon float figure as an example of use within a stormwater retention pond, a second valve control trigger is positioned on the siphon float. In a similar function as the first valve control trigger, the second valve control trigger is rotated as it contacts a second dowel peg and allows treated fluid to flow through for discharging the treated fluid from the batch reactor system.

Referencing the siphon float figure as an example of use within a stormwater retention pond, the valves could be controlled by pressure which opens and closes the valves as they rise with and lower with in fluid elevations in the stormwater pond relinquishing the requirement of control dowels pegs and valve triggers.

A control dowel extending between the bottom of a batch reactor system, at a floor or bottom surface, to above a surface or bank of the batch reactor is anchored to the bottom and remaining static between the bottom of the batch reactor and above the maximum possible elevation of fluid within the system. In an embodiment, the control dowel is a static part of the siphon float system which defines the horizontal position of the float allowing the float to slide vertically up and down the dowel.

A timer could be provided based on design requirements in communication with the first valve control lever and the timer is initiated by the rotation of the valve control trigger. The rotation of the valve control trigger is based on the a fill level of the batch reactor. The timer is mechanically connected to at least one of the plurality of valves. The valve to which it is connected operates to release or discharge fluid from the batch reactor system.

The normal level of fluid within a batch reactor system is generally referred to as the mean high elevation. This level is predetermined based on statistical analysis and or reports based on the size and elevation of the batch reactor. One or more support legs based upon design requirements, may provide structural support and integrity to the siphon float. For example, if a stormwater pond fills with sediment above the mean high water elevation, or the body of water is dewatered to the bottom of the pond leaving the system standing on its own, the support legs will act to provide structural rigidity to the system absent flotation support.

Using a stormwater retention pond as an example, Supplemental elevation analysis include at least start elevation, average storm elevation, design storm elevation, and emergency overflow elevation. Start elevation or normal water elevation is defined by an elevation above the mean high water table and the elevation at which without disturbance, the water level should remain static and defines the position of the first dowel peg in the control dowel figure. The average storm elevation is the maximum elevation during a common storm incident. The average storm elevation also defines a general position for the placement of the second dowel peg in the control dowel figure. The design storm elevation is a relatively extreme level identifying a maximum level of the design storm and an emergency outfall elevation. An emergency overflow elevation acts to dewater the body of water during a catastrophic event exceeding the elevation of the design storm elevation.

In addition to the stormwater retention pond example, a sediment storage area fills with sediment while it sinks into the body of water. The sediment stored within the sediment storage will remain submerged protecting it against wind, leakage, or other environmental factors acting that disperse sediment and contaminate downstream waterbodies. In an embodiment, sediment stored within the storage can be selectively removed. Further, the sediment storage can be selectively adjusted based on the required volume of storage.

In an embodiment, the complete system is removeable from the bottom of the batch reactor system. Displacement of the entire system can be achieved by removing structural components from the bottom of the batch reactor system and transplanting said components to a separate or different batch reactor system for intended use.

In an embodiment, the filling of the siphon pipe charges the system and the remaining operation functions under hydraulic pressures of fluid within the siphon pipe and the system generally. For example, if a major drought or other event causes a stormwater retention pond to completely drain, the plurality of valves will operate to retain water within the siphon pipe allowing operation of the system upon a refilling of the body of water.

The system operates to control levels of fluid within a batch reactor system for control of erosion or other purposeful requirements to access or adjust the elevation of fluid within a batch reactor system. For example, in a stormwater retention pond, the siphon float prematurely degrades the volume of stormwater, creating the capacity for the pond to capture stormwater without releasing any stormwater into downstream waterbodies within the range of the degraded volume. Additionally, the siphon would be strategically located at the center of the stormwater pond an order to give particles the maximum distance to travel and sink below the inlets of the siphon pipe and trapping those particles in the pond and removing treated stormwater.

Other uses of the system may include treatment of sewer systems and infrastructure within the body of water. For example, where a bath reactor deposits particles within the body of water, removal of such particles is achieved by precise control of elevation of the water within the body of water to expose or facilitate removal of the particles.

In an alternative embodiment, filters are disposed to remove particulate from discharged fluid through the siphon hose whereby discharged fluid flows through the siphon hose and terminates at a distribution box and distributed to filters or infiltration techniques that further treat the fluid.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A siphon float system comprising:
a. a central dowel in communication with a batch reactor;
b. a siphon float slidably engaged with the central dowel, wherein the siphon float is hydraulically operated;
c. a plurality of valves in communication with the siphon float, wherein the plurality of valves selectively control a flow of water;
d. one or more dowel pegs, wherein the one or more dowel pegs contact one or more valve triggers based on a level of fluid in the batch reactor; and
e. a plurality of hoses to direct the flow of water.

2. The siphon float system of claim 1, wherein the siphon float is hydraulically operated through a method comprising the steps of:
a. submerging the siphon float into the batch reactor;
b. a siphon pipe in communication with the siphon float filling with water and the water displacing air within the system;
c. the siphon float managing a level of the batch reactor based on the mean high water elevation.

3. The siphon float system of claim 1, further comprising one or more filters disposed within the siphon float.

4. The siphon float system of claim 1, wherein the siphon float further comprises:
a. one or more legs configured to engage a bottom surface of the batch reactor;
b. a floatation base attached to the one or more legs, wherein the plurality of valves are disposed on the floatation base;
c. a siphon pipe extending outward from the floatation base, wherein the plurality of valves control the flow of water within the siphon pipe.

5. The siphon float system of claim 4, further comprising a delay trigger system in control with the plurality of valves, wherein the delay trigger system controls selective operation of the plurality of valves.
